(19) United States
(12) Patent Application Publication
(10) Pub. No.: US 2009/0204879 A1
(43) Pub. Date: Aug. 13, 2009

(54) SYSTEM AND METHOD FOR SCRIPT LANGUAGE-BASED DOCUMENT PROCESSING

(76) Inventors: William Su, Riverside, CA (US); Hongfeng Wei, Cerritos, CA (US); Jianxin Wang, Trabuco Canyon, CA (US); Giri Natarajan, La Palma, CA (US); Mohammad Suleiman, Trabuco Canyon, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/027,436

(22) Filed: Feb. 7, 2008

(51) Int. Cl. G06F 17/27

(52) U.S. Cl. 715/200

(57) ABSTRACT

The subject application is directed to a system and method for script language-based document processing. First, an electronic document inclusive of scripted commands is received. Scripted commands are then parsed from the received electronic document. At least one electronic document is then retrieved from an associated storage in accordance with the parsing of the scripted commands from the received electronic document. Thereafter, at least one document processing operation is performed on each retrieved electronic document in accordance with the scripted command parsed from the received electronic document.

### BACKGROUND OF THE INVENTION

The subject application is directed generally to the use of electronic documents inclusive of scripting language for control, configuration, and document retrieval relative to document processing devices. The subject application is particularly applicable to document processing operations in which such scripting language is used as a mechanism to direct operation of a document processing operation or device simply by communicating requisite instructions in a fashion similar to sending a document for an output operation, such as printing.

Document processing devices include functions for printing, scanning, electronic mailing, copying, and the like. More recently, devices include more than one of these functions, and are referred to as multifunction peripherals or MFPs. Many document processing devices are shared among users, allowing for savings in equipment cost and maintenance costs associated with relatively complex devices.

Document processing devices are typically shared via a network, either via hardwired connections, such as Ethernet or Token-Ring, or via a wireless connection, such as WiFi or WiMax connectivity. A typical, networked document processing operation incorporates a networked workstation which is used for creation or retrieval of electronic documents, and routing them to a document processing device for processing, such as printing or facsimile transmission.

When operations are desired on multiple documents, it is incumbent on a user to retrieve each document, either locally or via a document repository, such as a networked server, and then communicate each document to a processing device, along with instructions for one or more desired operations to be performed.

### SUMMARY OF THE INVENTION

In accordance with one embodiment of the subject application, there is provided a system and method directed to using electronic documents inclusive of scripting language for control, configuration, and document retrieval relative to document processing devices.

Further, in accordance with one embodiment of the subject application, there is provided a system and method directed to document processing operations in which such scripting language is used as a mechanism to direct operation of a document processing operation or device simply by communicating requisite instructions in a fashion similar to sending a document for an output operation, such as printing.

Still further, in accordance with one embodiment of the subject application, there is provided a system for script language-based document processing. The system comprises means adapted for receiving an electronic document inclusive of scripted commands and parsing means adapted for parsing scripted commands of a received electronic document. The system also comprises retrieval means adapted for retrieving at least one electronic document from an associated storage in accordance with a parsing of scripted commands by the parsing means and means adapted for performing at least one document processing operation on each retrieved electronic document in accordance with parsed commands.

In one embodiment of the subject application, the scripted commands include search criteria, and wherein the retrieval means further includes means adapted for retrieving the at least one electronic document in accordance with a comparison with the search criteria.

In another embodiment of the subject application, the scripted commands include configuration data adapted for setting a configuration of an associated document processing device.

In a further embodiment of the subject application, the system also comprises means adapted for testing received electronic document data for errors in scripted commands therein and means adapted for selectively operating the retrieval means in accordance with an output of the testing means.

In yet another embodiment, the parsed commands include instructions for performing at least one document processing operation selected from a set comprising printing, copying, optical character recognition, facsimile transmission and electronic mail transmission.

In another embodiment of the subject application, the scripted commands include template data adapted for creating a scan template associated with at least one document scanning operation.

Still further, in accordance with one embodiment of the subject application, there is provided a method for script language-based document processing in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for script language-based document processing according to one embodiment of the subject application;

FIG. 2 is a block diagram illustrating controller hardware for use in the system for script language-based document processing according to one embodiment of the subject application;

FIG. 3 is a functional diagram illustrating the controller for use in the system for script language-based document processing according to one embodiment of the subject application;

FIG. 4 is a block diagram illustrating a user device for use in the system for script language-based document processing according to one embodiment of the subject application;

FIG. 5 is a flowchart illustrating a method for script language-based document processing according to one embodiment of the subject application; and

FIG. 6 is a flowchart illustrating a method for script language-based document processing according to one embodiment of the subject application.

### DETAILED DESCRIPTION OF THE PREFERRED EMBODIMENT

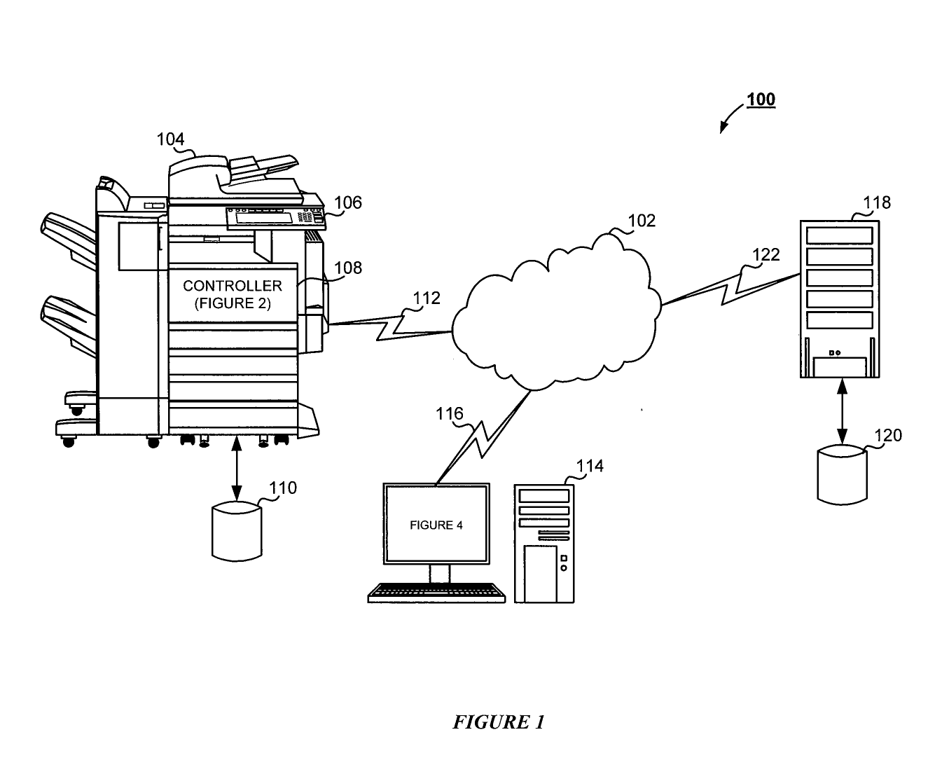

The subject application is directed to a system and method for using electronic documents inclusive of scripting language for control, configuration, and document retrieval relative to document processing devices. In particular, the subject application is directed to a system and method for document processing operations in which such scripting language is used as a mechanism to direct operation of a document processing operation or device simply by communicating requisite instructions in a fashion similar to sending a document for an output operation, such as printing. It will become apparent to those skilled in the art that the system and method described herein are suitably adapted to a plurality of varying electronic fields employing scripted commands, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for script language-based document processing in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

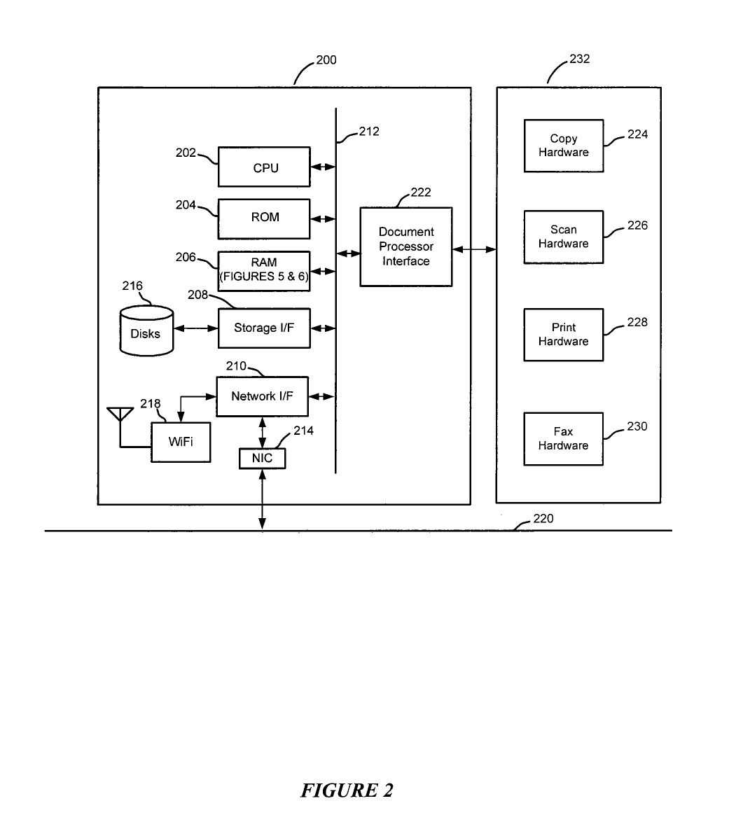

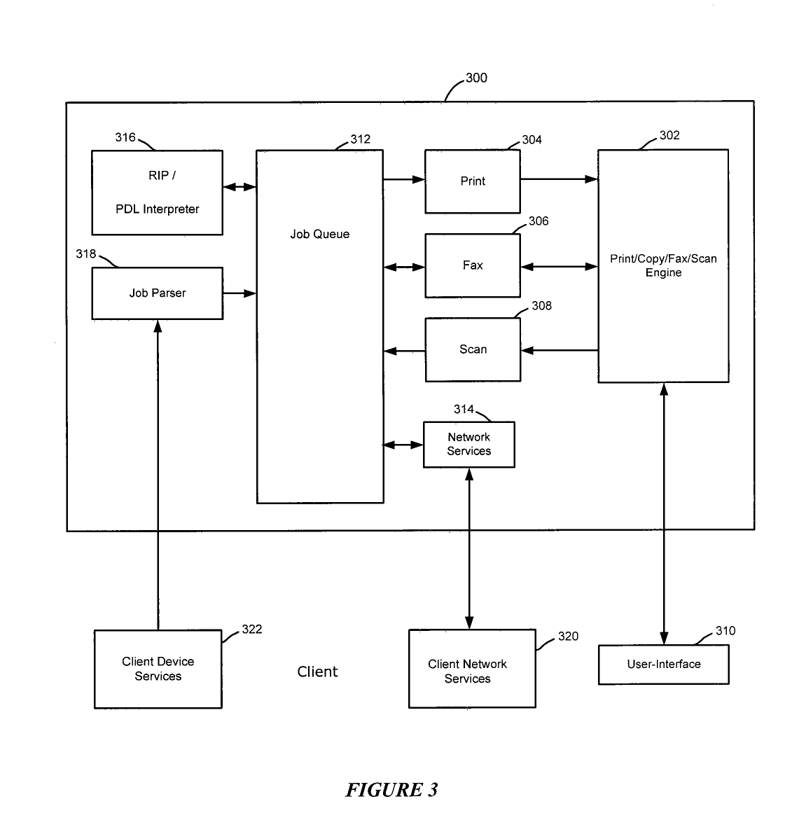

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for script language-based document processing of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, template data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

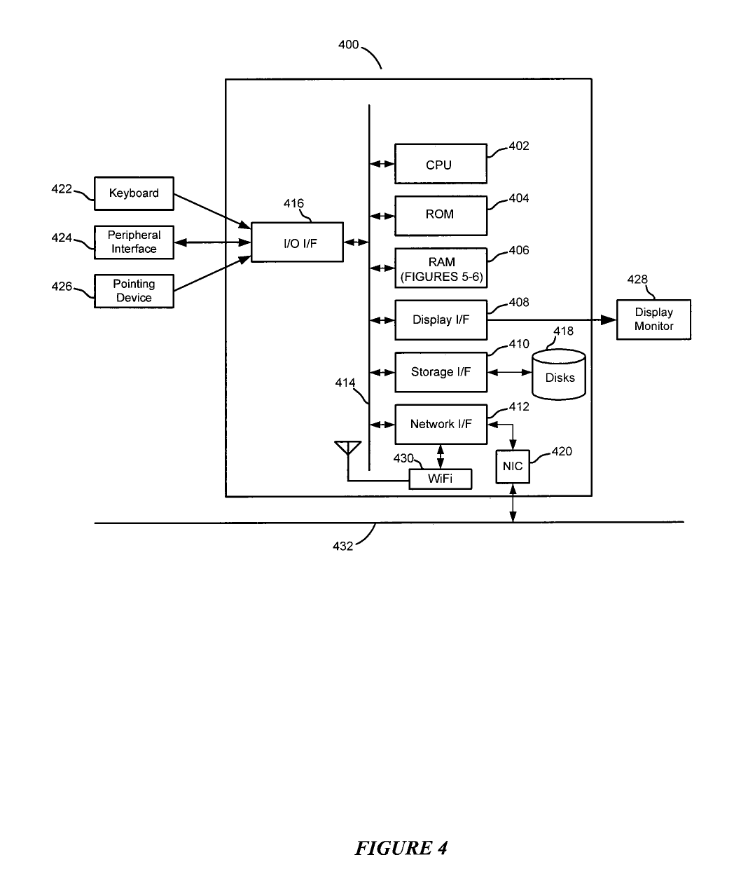

The system 100 illustrated in FIG. 1 further depicts a user device 114 in data communication with the computer network 102 via a communications link 116. It will be appreciated by those skilled in the art that the user device 114 is shown in FIG. 1 as a computer workstation for illustration purposes only. As will be understood by those skilled in the art, the user device 114 is representative of any personal computing device known in the art, including, for example and without limitation, a laptop computer, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, high-language script commands, user interface modifications, upgrades, updates, personalization data, or the like, to the document processing device 104, or any other similar device coupled to the computer network 102. The functioning of the user device 114 will better be understood in conjunction with the block diagram illustrated in FIG. 4, explained in greater detail below.

The system 100 of FIG. 1 also includes a document management system, illustrated by the document management server 118 and associated data storage device 120, communicatively coupled to the computer network 102 via a communications link 122. It will be appreciated by those skilled in the art that the document management server 118 comprises hardware, software, and combinations thereof suitably adapted to provide one or more services, web-base applications, storage options, and the like, to networked devices. In accordance with one embodiment of the subject application, the document management server 118 includes various components, implemented as hardware, software, or a combination thereof, for managing the retention of electronic documents, searching for documents, retrieval for documents, and the like, which are accessed via the computer network 102. The communications link 122 is any suitable data communications means known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. It will be appreciated by those skilled in the art that the components for managing electronic documents described with respect to the document management server 118 hereinafter are capable of implementation on any computing device coupled to the computer network 102 and functioning as a document management system.

Communicatively coupled to the document management server 118 is the data storage device 120. In accordance with the preferred embodiment of the subject application, the data storage device 120 is any mass storage device known in the art including, for example and without limitation, magnetic storage drives, a hard disk drive, optical storage devices, flash memory devices, or any suitable combination thereof. In the preferred embodiment, the data storage device 120 is suitably adapted to store software updates, update lists, electronic database data, document data, image data, or the like. It will be appreciated by those skilled in the art that while illustrated in FIG. 1 as being a separate component of the system 100, the data storage device 120 is capable of being implemented as internal storage component of the document management server 118, or the like, such as, for example and without limitation, an internal hard disk drive, or the like.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by the processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the controller 200. By way of example, illustrated is at least one network interface card 214 for data communication with fixed or wired networks, such as Ethernet, token ring, and the like, and a wireless interface 218 suitably adapted for wireless communication via means such as WiFi, WiMax, wireless modem, cellular network, or any suitable wireless communication system. It is to be appreciated however, that the network interface subsystem 210 suitably utilizes any physical or non-physical data transfer layer or protocol layer as will be appreciated by one of ordinary skill in the art. In the illustration, the network interface 214 is interconnected for data interchange via a physical network 220 suitably comprised of a local area network, wide area network, or a combination thereof.

Data communication between the processor 202, read only memory 204, random access memory 206, storage interface 208, and the network interface subsystem 210 is suitably accomplished via a bus data transfer mechanism, such as illustrated by bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306, or scan 308.

Finally, the job queue 312 is in data communication with a job parser 318, which job parser suitably functions to receive print job language files from an external device, such as client device services 322. The client device services 322 suitably include printing, facsimile transmission, or other suitable input of an electronic document for which handling by the controller function 300 is advantageous. The job parser 318 functions to interpret a received electronic document file and relay it to the job queue 312 for handling in connection with the afore-described functionality and components.

Turning now to FIG. 4, illustrated is a hardware diagram of a suitable workstation 400, illustrated in FIG. 1 as the user device 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by one of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, an electronic document inclusive of scripted commands is first received. Next, scripted commands are parsed from the received electronic document. At least one electronic document is then retrieved from an associated storage in accordance with the parsing of the scripted commands from the received electronic document. Thereafter, at least one document processing operation is performed on each retrieved electronic document in accordance with the scripted command parsed from the received electronic document.

In accordance with one example embodiment of the subject application, an electronic document is generated by the user device 114 inclusive of scripted commands. Preferably, a user associated with the user device 114 writes a high-level scripting language-based document inclusive corresponding to desired actions, searches, or other operations to be performed by an associated document processing device 104. For example, the user is capable of including scripted commands corresponding to the search and retrieval of a plurality of electronic documents from the document management server 118, configuring the document processing device 104, e.g. wireless or network settings, printing options, etc., creating a template, e.g. a scan template, perform a desired document processing operation on selected electronic documents, e.g. printing, copying, optical character recognition, facsimile transmission, electronic mail transmission or other such task to be performed.

The skilled artisan will appreciate that the high-level script language, e.g. a fourth generation language, is capable of being understood by a plurality of devices, such as the document processing device 104. Preferably, the user associated with the user device 114 drafts the electronic document having scripted commands therein using such a scripting language. For example, when the user desires to the retrieve documents from the document management server 118 and print them via the document processing device 104, the scripted commands shown below, are capable of being generated in the electronic document.

| | |
|---|---|
| PRINT | print_list |
| | [FROM from_list] |
| | [WHERE conditions] |
| | [GROUP BY group_list] |
| | [ORDER BY order_list [ASC \| DESC]] |
| | [CONFIG config_list] |

It will be appreciated by those skilled in the art that “print_list” describes the list of all documents to be printed. In accordance with one embodiment of the subject application, the retrieval of more than one document is suitably accomplished with the separation of each desired document via a comma, semi-colon, or the like. In such an embodiment, the use of a symbol, such as an asterisk, is capable of being used to designate all documents in a given folder, with the “from_list” component setting forth the list of folders that participate in the query, with multiple folders separated with a comma, semi-colon, or the like. The “conditions ” set forth in the example document correspond to expressions that serve to limit the number of documents printed from the folder(s). For example, “WHERE author=“William Shakespeare” is a condition that restricts printing to only those documents authored by “William Shakespeare”; “WHERE date modified>=5/1/06 AND data modified<7/1/06” is a condition that restricts printing to only those documents modified on or after May 1, 2006 and before Jul. 1, 2006; “WHERE “Company” is a condition that restricts printing to only those documents on the storage medium 120 containing “Company”. The skilled artisan will further appreciate that the aforementioned conditions are also capable of being combined, e.g. through the use of “OR”, “AND”, and “NOT”, such as, for example and without limitation “WHERE “Company” AND date modified>=5/1/06 AND data modified<7/1/06”.

In accordance with one embodiment of the subject application, a further example of a script used is “group_list”, which if specified by the user, indicates that the document processing device 104 should group the documents prior to printing. For Example, “WHERE author=“William Shakespeare” AND author=“T. S. Elliot”, GROUP BY author” would direct the document processing device 104 to print all of William Shakespeare's documents as one output and all of T. S. Elliot's documents as one output. According to another embodiment of the subject application, a “config_list” script, if specified, would direct the received document processing device 104 to overwrite default configurations, e.g. number of copies, staples, hole-punch, or the like prior to printing, e.g. “CONFIG staple=TRUE”. Table 1, shown below, lists some examples of frequently used scripts in accordance with one embodiment of the subject application.

TABLE 1

| LANGUAGE | FUNCTION |
|---|---|
| PRINT * FROM FolderName | Retrieves all the |
| | documents in a folder. |
| PRINT * FROM FolderName | Retrieves documents that |
| WHERE document name = “document*” | meet search criteria, and |
| GROUP BY author | staple the documents by |
| CONFIG staple = TOPRIGHT, duplex = | author name |
| TRUE PRTNT document1, document2 | Retrieves specific |
| FROM FolderName | documents from a folder. |
| SCAN INTO FolderName | Scan documents into a |
| CONFIG resolution = 600 dpi, OCR = FALSE | folder. |
| FAX document1 FROM FolderName TO | Fax a document. |
| number1, number2 | |
| EMAIL document1 FROM FolderName | Email a document with |
| TO emailaddress1, emailaddress2 | a subject. |

Following the generation of the electronic document inclusive of the script commands, as explained above, the user device 114 communicates the electronic document to the document processing device 104 via the computer network 102. It will be understood by those skilled in the art that the communications between the user device 114 and the document processing device 104 is capable of being accomplished via a wireless or wired connection between the two, i.e. bypassing the computer network 102. The document processing device 104 then receives the electronic document from the user device 114 and parses any scripted commands contained therein. In accordance with one embodiment of the subject application the controller 108 or other suitable component associated with the document processing device 104 analyzes the received electronic document and determines that scripted commands are included, whereupon the controller 108 or other suitable component associated with the document processing device 104 parses those scripts from the document.

The controller 108 or other suitable component associated with the document processing device 104 then tests the parsed scripted commands to determine whether any errors in the commands are present. In the event that the controller 108 or other such component of the document processing device 104 detects one or more errors, a notification is returned to the user device 114 informing the user of the error.

When no errors are detected in the parsed scripted commands, the controller 108 or other suitable component associated with the document processing device 104 determines whether or not the scripted commands include configuration data representing a change, update, modification, or the like, to the configuration of the associated document processing device 104. Suitable examples of such configuration data include, for example and without limitation, scripted commands directed to network settings, wireless settings, document processing operation settings, and the like. In the event that the scripted commands do include configuration data, the controller 108 or other suitable component associated with the document processing device 104 implements the configuration data, as will be appreciated by those skilled in the art.

Upon the completing the implementation of the configuration data, or when no configuration script commands have been parsed from the electronic document, the controller 108 or other suitable component associated with the document processing device 104 then determines whether a scripted command corresponding to template creation was included in the received electronic document. For example, a user is able to direct the creation of a scan template corresponding to a scanning operation to be performed by the associated document processing device 104. Following execution of the scripted commands, the controller 108 or other suitable component of the document processing device 104 creates the template and stores the created template in the associated data storage device 110.

The controller 108 or other suitable component of the document processing device 104 then continues the processing of the scripted commands parsed from the received electronic document. Thus, when no further scripted commands remain, the operations with respect to the subject application terminate and the document processing device 104 returns to awaiting the next requested document processing operation from an associated user. When the controller 108 or other component of the document processing device 104 determines that one or more script commands corresponding to document processing are contained in the parsed commands, the search criteria, such as those conditions referenced above, are ascertained from the received electronic document. The controller 108 or other suitable component associated with the document processing device 104 then communicates the search criteria to the document management server 118 via the computer network 102.

The document management server 118 then compares the search criteria to electronic data stored in the associated data storage device 120 and retrieves one or more electronic documents from the data storage device 120 based on the comparison of the search criteria. The retrieved electronic documents are then returned to the document processing device 104 via the computer network 102. The electronic documents are then received by the document processing device 104 and the document processing operations associated with each received electronic document are determined in accordance with the parsed scripted commands. Thereafter, the document processing device 104 performs the determined document processing operations on each retrieved electronic document.

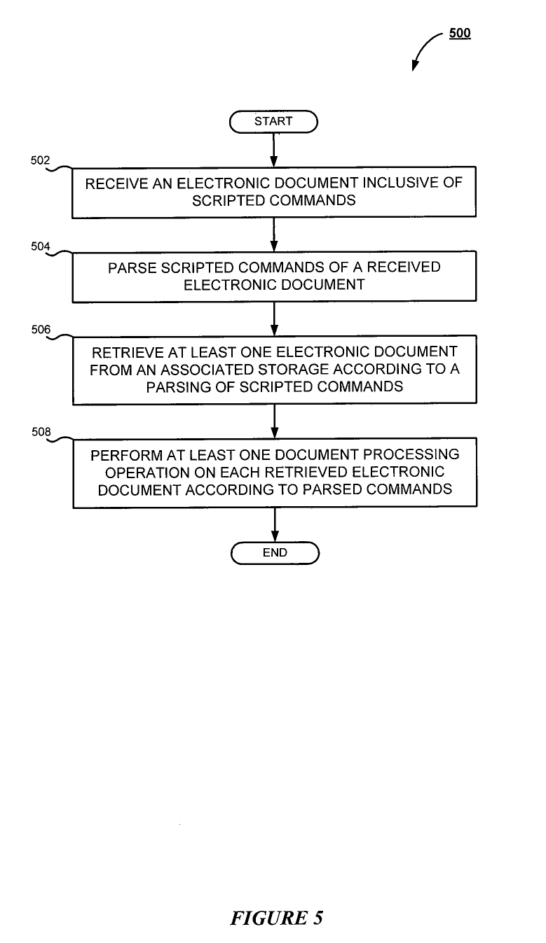

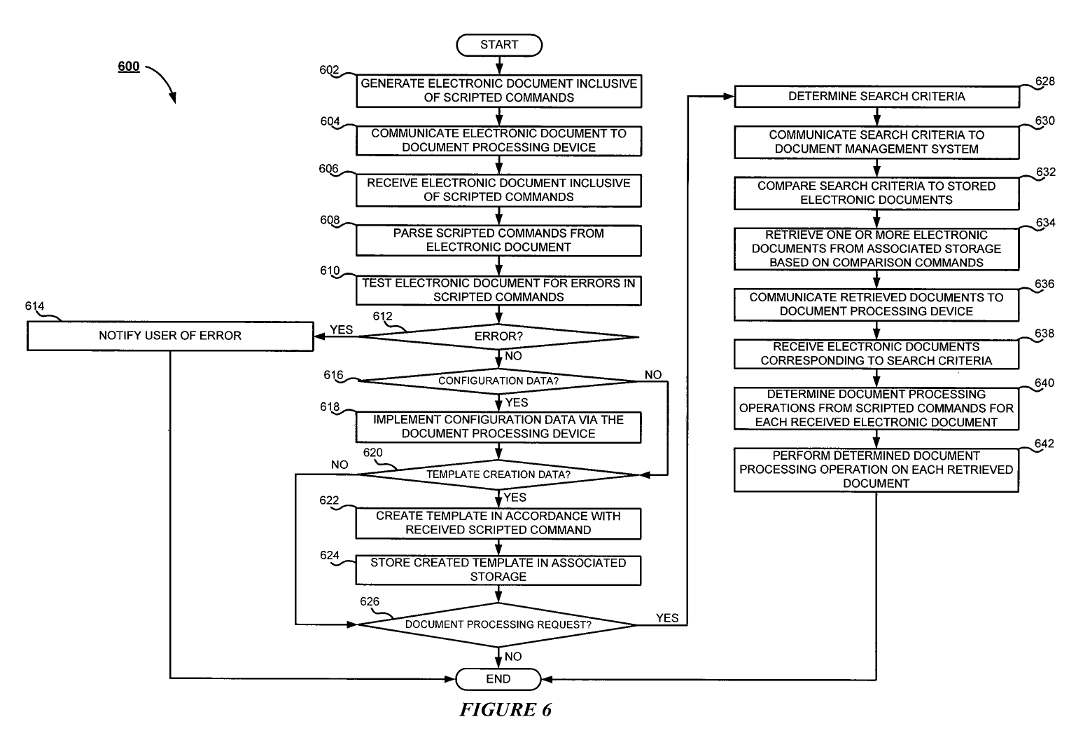

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for script language-based document processing in accordance with one embodiment of the subject application. Beginning at step 502, a document processing device 104 receives, from a user associated with the user device 114, an electronic document inclusive of scripted commands. The controller 108 or other suitable component associated with the document processing device 104 then parses the received electronic document at step 504 so as to ascertain the scripted commands contained therein.

At step 506, at least one electronic document is then retrieved from an associated storage in accordance with the parsing of the scripted commands from the received electronic document. In accordance with one embodiment of the subject application, electronic documents corresponding to the parsed scripted commands are retrieved from the document management server 118 via the computer network 102. The document processing device 104 then performs, at step 508, at least one document processing operation on each retrieved electronic document in accordance with the parsed scripted commands.

Referring now to FIG. 6, there is shown a flowchart 600 illustrating a method for script language-based document processing in accordance with one embodiment of the subject application. The methodology of FIG. 6 begins at step 602, whereupon the user device 114, via interactions with an associated user, generates an electronic document inclusive of scripted commands. As will be appreciated by those skilled in the art, high-level scripting language-based commands are input by the associated user corresponding to electronic document retrieval, document processing operations, document processing device configuration, document processing operation templates, and the like. At step 604, the generated electronic document is communicated to the document processing device 104 from the user device 114 via the computer network 102.

The controller 108 or other suitable component associated with the document processing device then receives the electronic document at step 606. At step 608, the received electronic document is parsed by the controller 108 or other suitable component associated with the document processing device 104 to ascertain any scripted commands therefrom. At step 610, the received electronic document is tested for any errors in the scripted commands. That is, the controller 108 tests the parsed scripted commands to determine whether any errors, e.g. syntax, command, incompatibilities, or the like, are present. A determination is then made at step 612 whether or not any errors are present in the parsed scripted commands. When one or more errors are detected by the controller 108, flow proceeds to step 614, whereupon the user associated with the user device 114 is notified via any suitable means known in the art. For example and without limitation, an error message is capable of being generated by the document processing device 104 and returned to the user device 114 via the computer network 102 indicating the nature of such detected errors. When the step 614 is completed, operations of the methodology depicted in FIG. 6 terminate.

Upon a determination at step 612 that no errors are present in the parsed scripted commands, flow proceeds to step 616. At step 616, a determination is made whether any of the parsed scripted commands correspond to configuration commands. That is, whether the scripted commands include configuration data corresponding to a change, update, modification, or the like, to the configuration of the associated document processing device 104. The skilled artisan will appreciate that such configuration data includes, for example and without limitation, scripted commands directed to network settings, wireless settings, document processing operation settings, and the like. Upon a positive determination at step 616, flow proceeds to step 618, whereupon the controller 108 or other suitable component associated with the document processing device 104 implements the configuration data, as will be appreciated by those skilled in the art.

Following completion of the implementation of the configuration data at step 618, or upon a determination at step 616 that no configuration scripted commands were contained in the received electronic document, flow proceeds to step 620. At step 620, a determination is made by the controller 108 or other suitable component associated with the document processing device 104 whether the received electronic document includes a scripted command corresponding to template creation. As will be appreciated by those skilled in the art, such template creation operations include, for example and without limitation, a scan template corresponding to a scanning operation to be performed by the associated document processing device 104. A positive determination at step 620 prompts the controller 108 or other suitable component associated with the document processing device 104 to create a template in accordance with the corresponding scripted commands parsed from the received electronic document at step 622. The template is then stored, at step 624, in the data storage device 110 associated with the document processing device 104 for later use thereby.

Following storage of the newly created template at step 624, or upon a determination at step 620 that no template creation commands were present in the received electronic document, flow progresses to step 626. A determination is then made at step 626 whether the parsed scripted commands correspond to a document processing request. That is, whether the scripted commands correspond to the search and retrieval of one or more electronic documents from the document management server 118 and the subsequent performance thereon of corresponding document processing operations, e.g. printing, copying, optical character recognition, facsimile transmission, electronic mail transmission, and the like. Upon a negative determination at step 626, operations of the methodology depicted in FIG. 6 terminate.

Upon positive determination at step 626, flow proceeds to step 628, whereupon search criteria is determined in accordance with the scripted commands parsed from the electronic document. Suitable search criteria, as described in greater detail above, include, for example and without limitation, author, keywords, modification dates, groups, and the like. The search criteria, as determined from the parsed scripted commands, are then communicated to the document management server 118 via the computer network 102 at step 630. The document management server 118 then compares the received search criteria to electronic documents stored on associated data storage device 120 at step 632.

One or more electronic documents are then retrieved by the document management server 118 from the data storage device 120 in accordance with the comparison of the search criteria at step 634. At step 636, the document management server 118 communicates the retrieved electronic documents via the computer network 102 to the document processing device 104. At step 638, the document processing device 104 receives the retrieved electronic documents from the document management server 118. The controller 108 or other suitable component associated with the document processing device 104 then determines, at step 640, at least one document processing operation for each received electronic document in accordance with the parsed scripted commands. At step 642, the document processing device 104 performs the determined document processing operations on each retrieved electronic document.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application, and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally, and equitably entitled.

What is claimed:

1. A script language-based document processing system comprising:
means adapted for receiving an electronic document inclusive of scripted commands;
parsing means adapted for parsing scripted commands of a received electronic document;
retrieval means adapted for retrieving at least one electronic document from an associated storage in accordance with a parsing of scripted commands by the parsing means; and
means adapted for performing at least one document processing operation on each retrieved electronic document in accordance with parsed commands.

2. The system of claim 1 wherein the scripted commands include search criteria, and wherein the retrieval means further includes means adapted for retrieving the at least one electronic document in accordance with a comparison with the search criteria.

3. The system of claim 1 wherein the scripted commands include configuration data adapted for setting a configuration of an associated document processing device.

4. The system of claim 1 further comprising:
means adapted for testing received electronic document data for errors in scripted commands therein; and
means adapted for selectively operating the retrieval means in accordance with an output of the testing means.

5. The system of claim 1 wherein the parsed commands include instructions for performing at least one document processing operation selected from a set comprising printing, copying, optical character recognition, facsimile transmission and electronic mail transmission.

6. The system of claim 1 wherein the scripted commands include template data adapted for creating a scan template associated with at least one document scanning operation.

7. A method for script language-based document processing comprising the steps of:
receiving an electronic document inclusive of scripted commands;
parsing scripted commands of a received electronic document;
retrieving at least one electronic document from an associated storage in accordance with a parsing of scripted commands; and
performing at least one document processing operation on each retrieved electronic document in accordance with parsed commands.

8. The method of claim 7 wherein the scripted commands include search criteria, and wherein retrieving the at least one electronic document is in accordance with a comparison with the search criteria.

9. The method of claim 7 wherein the scripted commands include configuration data adapted for setting a configuration of an associated document processing device.

10. The method of claim 7 further comprising the steps of:
testing received electronic document data for errors in scripted commands therein; and
selectively retrieving the at least one electronic document from the associated storage in accordance with an output of the testing.

11. The method of claim 7 wherein the parsed commands include instructions for performing at least one document processing operation selected from a set comprising printing, copying, optical character recognition, facsimile transmission, and electronic mail transmission.

12. The method of claim 7 wherein the scripted commands include template data adapted for creating a scan template associated with at least one document scanning operation.
